(19) United States
(12) Patent Application Publication
(10) Pub. No.: US 2003/0101037 A1
(43) Pub. Date: May 29, 2003

(54) Simulation apparatus and simulation method

(75) Inventors: Naoki Kusunoki, Fuchu-Shi (JP); Nobutoshi Aoki, Yokohama-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHHIKI KAISHA TOSHIBA, Tokyo (JP)

(21) Appl. No.: 10/054,994

(22) Filed: Jan. 25, 2002

(30) Foreign Application Priority Data
Nov. 28, 2001 (JP) 2001-362629

(51) Int. Cl. G06F 17/50

(52) U.S. Cl. 703/14

(57) ABSTRACT

A simulation apparatus configured to estimate properties of a semiconductor device, comprising: a first calculating part configured to calculate a first value corresponding to a prescribed physical property value by taking a prescribed physical quantity into consideration, with regard to at least a partial region of said semiconductor device; a second calculating part configured to calculate a second value corresponding to said physical property value without taking said physical quantity into consideration, with regard to at least a partial region of said semiconductor device, and a visualizing part configured to display, in a prescribed form, a correlation between said first and second values.

### CROSS REFERENCE TO RELATED APPLICATIONS

This application is based upon and claims the benefit of priority from the prior Japanese Patent Applications No. 2001-362629, filed on Nov. 28, 2001, the entire contents of which are incorporated herein by reference.

### BACKGROUND OF THE INVENTION

1. Field of the Invention

The present invention relates to a simulation apparatus and a simulation method for estimating properties of a semiconductor device by taking into consideration a stress having occurred during the fabrication of the semiconductor device.

2. Related Background Art

With the progress of micro fabrication technology, it has become impossible to develop semiconductor devices without taking into consideration the effects given by a stress occurring during fabrication of the semiconductor devices. For example, there is a problem that the mobility of electrons becomes low due to a compression stress occurring in a substrate, thereby decreasing the current value of an N-MOSFET as compared with the case where the compression stress is lower.

On the other hand, a P-MOSFET has an advantage that the current value increases in accordance with the increase in the mobility of holes, thereby improving device properties.

Besides the above-described matters, because the stress occurring in the semiconductor device has influence on the impurity diffusion and the shape of the semiconductor device, a semiconductor process device simulation capable of easily taking a countermeasure for the stress is important.

In the conventional semiconductor process device simulation, the value of stress occurring during the fabrication of the semiconductor device is calculated, a stress distribution in the semiconductor device is displayed, and based on the displayed result, effects of the stress on the device properties has been estimated experientially.

For example, FIG. 9A shows a conventional example of displaying the stress distribution with contours in an area right under the gate shown in FIG. 9B. FIG. 9A displays the contours of the stress value based on the stress value calculated by using a stress simulator.

Because the stress distribution shown in FIG. 9A is only information for estimating the effect of the stress, it was difficult to quantitatively estimate the effect of the stress on the device properties.

### SUMMARY OF THE INVENTION

A simulation apparatus configured to estimate properties of a semiconductor device, comprising:

a first calculating part configured to calculate a first value corresponding to a prescribed physical property value by taking a prescribed physical quantity into consideration, with regard to at least a partial region of said semiconductor device;

a second calculating part configured to calculate a second value corresponding to said physical property value without taking said physical quantity into consideration, with regard to at least a partial region of said semiconductor device, and

a visualizing part configured to display, in a prescribed form, a correlation between said first and second values.

### BRIEF DESCRIPTION OF THE DRAWINGS

FIG. 1 is a block diagram showing schematic configuration of a first embodiment of a simulation apparatus according to the present invention.

FIG. 2 is a flow chart showing processes of the simulation apparatus of FIG. 1.

FIG. 3A is a diagram showing the stress distribution in a silicon substrate right under the gate.

FIG. 3B is a diagram showing an example of the changing amount μ(σ)/μ of the mobility of the electrons.

FIG. 4 is a flow chart showing processes of the second embodiment of a simulation apparatus according to the present invention.

FIG. 5A shows the stress distribution in the silicon substrate right under the gate, similarly to FIG. 3A, and FIG. 5B is a diagram showing the process result of the step S16 of FIG. 4.

FIG. 6 is a flow chart showing processes of the third embodiment of a simulation apparatus according to the third embodiment.

FIG. 7A is the stress distribution occurring in the silicon substrate of the bulk, FIG. 7B is the stress distribution occurring in the SOI substrate, and FIG. 7C is a diagram showing the changing amount of the mobility of the electrons calculated from the stress distribution of FIG. 7B.

FIG. 8 is a diagram showing overall configuration of a simulation apparatus according to the present invention in the case of using a computer.

FIG. 9A is a diagram showing the conventional example for displaying with the contour line the stress distribution right under the gate, and FIG. 9B is a top face view of the semiconductor device.

### DESCRIPTION OF THE PREFERRED EMBODIMENTS

Hereinafter, a simulation apparatus and a simulation method according to the present invention will be specifically described with reference to drawings.

(First Embodiment)

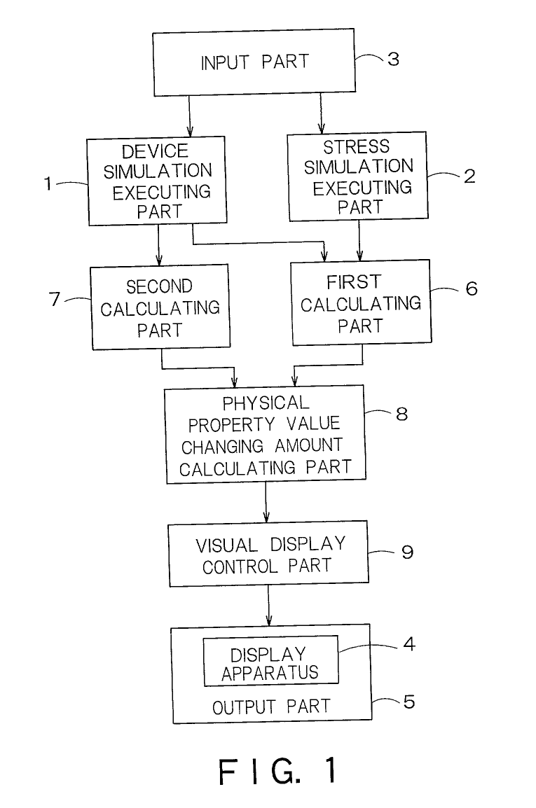

FIG. 1 is a block diagram showing schematic configuration of a first embodiment of a simulation apparatus according to the present invention. The simulation apparatus of FIG. 1 has a device simulation executing part 1 for executing a simulation for a property estimation of a semiconductor device based on a prescribed fabrication condition, a stress simulation executing part 2 for executing a stress simulation occurring in the semiconductor device, an input part 3 for inputting a fabrication condition and so on for the simulation, an output part 5 having a display apparatus 4 for outputting the simulated result, a first calculating part 6 for calculating a physical property value such as a mobility by taking into consideration the stress distribution in the semiconductor device, a second calculating part for calculating the physical property value without taking the stress distribution in the semiconductor device, a physical property value changing amount calculating part 8 for calculating the changing amount of the physical property value obtained by taking the stress into consideration with regard to the physical property value obtained without taking the stress into consideration, and a visualizing display control part 9 for visually displaying the result calculated by the physical property changing amount calculating part 8.

The device simulation executing part 1 executes the simulation with regard to the fabrication processes such as oxidation, diffusion, deposition, etching and ion implantation of the semiconductor device.

The physical property values calculated by the first and second calculating parts 6 and 7 is, for example, a carrier mobility, carrier trap, a fixed electrical charge, a tunnel probability, a lifetime of carrier, a generation-extinction speed of pair of carriers, a diffusion coefficient, a viscous coefficient, and physical property values relating thereto.

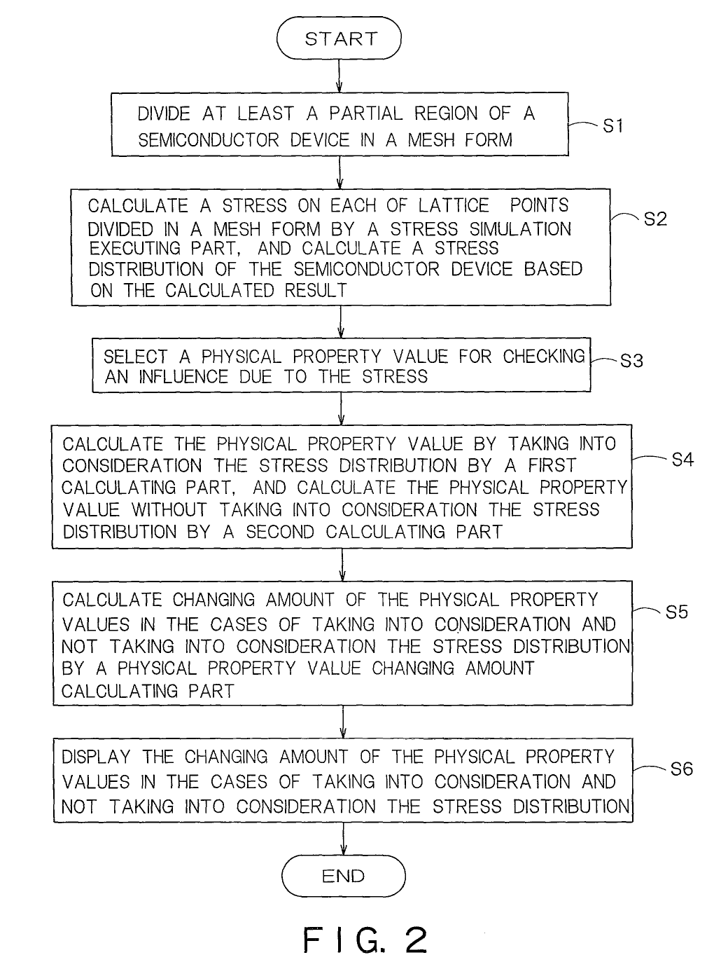

FIG. 2 is a flow chart showing processes of the simulation apparatus of FIG. 1. First of all, at least a partial region of the semiconductor device is divided on mesh form (step S1). Subsequently, the stress simulation calculation executing part 2 calculates the stress on each of grid points divided on mesh form, and calculates the stress distribution of the semiconductor device based on the calculated result of the stress (step S2).

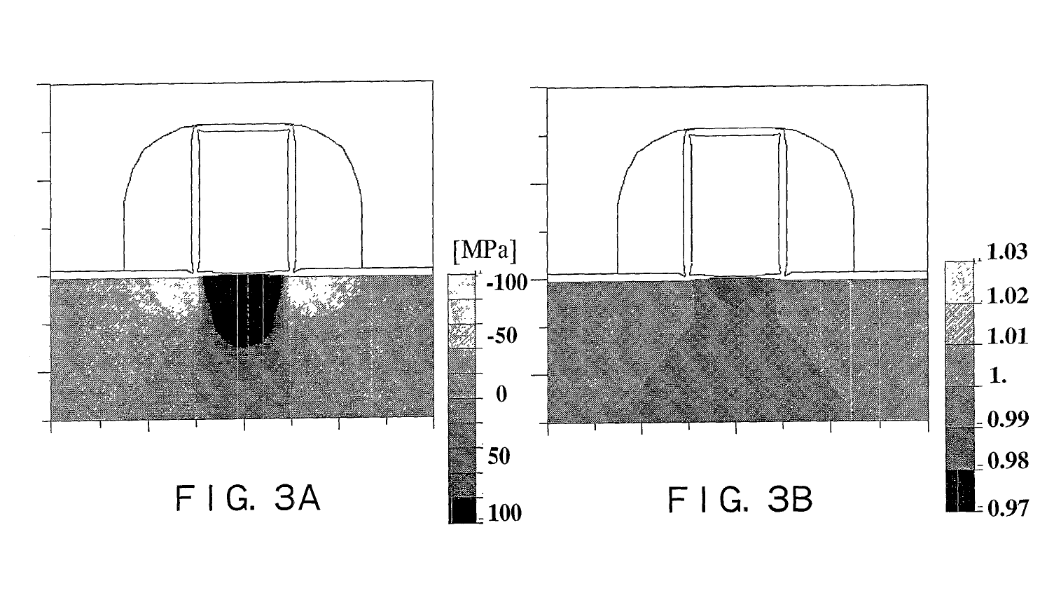

FIG. 3A is a diagram showing the stress distribution in a silicon substrate right under the gate. In FIG. 3A, the deeper the color is, the stronger the compression stress is, and the lighter the color is, the stronger the tensile stress is. As shown in FIG. 3A, the nearer to the surface the region is, the stronger the compression stress is. The stress of FIG. 3A expresses a hydrostatic pressure obtained as an average between the stress in a crosswise direction and the stress in a lengthwise direction.

Next to the step S2, the physical property value for looking into effects due to the stress is selected (step S3). Here, as described above, the carrier mobility and so on are selected.

Subsequently, the first calculating part 6 calculates the physical property value selected by the step S3 by taking the stress distribution into consideration. Furthermore, the second calculating part 7 calculates the physical property value selected by the step S3 without taking the stress distribution into consideration (step S4).

Subsequently, the physical property value changing amount calculating part 8 calculates the changing amount of the physical property values in the cases of taking the stress distribution into consideration and not taking the stress distribution into consideration (step S5). For example, with regard to the mobility of the carrier, the physical property value changing amount calculating part 8 calculates the changing amount μ(σ)/μ of the mobility μ(σ) in the case of taking the stress distribution into consideration relative to the mobility μ in the case of not taking the stress distribution into consideration. With regard to the diffusion coefficient, it calculates the changing amount D(σ)/D of the diffusion coefficient D(σ) in the case of taking the stress distribution relative to the diffusion coefficient D in the case of not taking the stress distribution into consideration. With regard to the viscous coefficient, it calculates the changing amount η(σ)/η of the viscous coefficient η(σ) in the case of taking the stress distribution into consideration relative to the viscous coefficient η in the case of not taking the stress distribution into consideration.

Subsequently, the visualizing display control part 9 displays the calculated result of the step S5 on the display apparatus 4 (step S4). FIG. 3B is a diagram showing an example of the changing amount μ(σ)/μ of the mobility of the electrons. As shown in FIG. 3B, the mobility of the electron becomes low by 1-2% in the surface region due to an influence of the compression stress occurring in the silicon substrate right under the gate.

Thus, the present embodiment visually displays the changing amount of the physical property value in the cases of taking the stress distribution into consideration and not taking the stress distribution into consideration. Accordingly, it is possible to quantitatively and visually estimate how a diffusion length changes when the physical property value is the diffusion coefficient, how a relaxation time changes when the physical property value is the viscous coefficient, or how a current value when the physical property value is the carrier mobility, due to the stress. Furthermore, it is possible to easily grasp which part in the semiconductor device is affected by each of the physical property values.

In the above-mentioned embodiment, although the example of calculating the physical property value obtained by taking the stress into consideration has been described, the physical quantity to be taken into consideration is not limited to the stress. For example, the physical property value such as the diffusion coefficient may be calculated by taking concentrations of the electrons and the holes into consideration.

(Second Embodiment)

A second embodiment has a feature that the changing amount of the physical property value is displayed on the distribution of the physical distribution in a superimposing manner.

Because the second embodiment has a block configuration similar to that of FIG. 1, a detailed description will be omitted hereinafter.

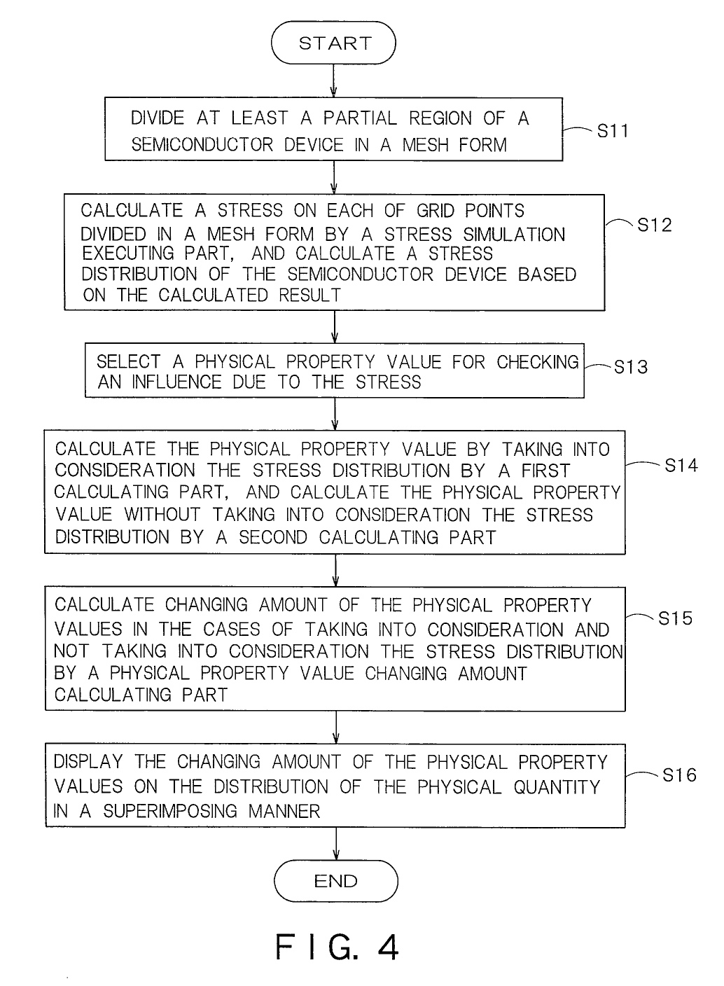

FIG. 4 is a flow chart showing processes of the second embodiment of a simulation apparatus according to the present invention. The steps S11-S15 of FIG. 4 are the same as the steps S1-S5 of FIG. 2. After the process of the step S15 has been finished, the visualizing display control part 9 displays the changing amount such as μ(σ)/μ or D(σ)/D of the physical property value on the distribution of the physical amount (step S16) in the superimposing manner.

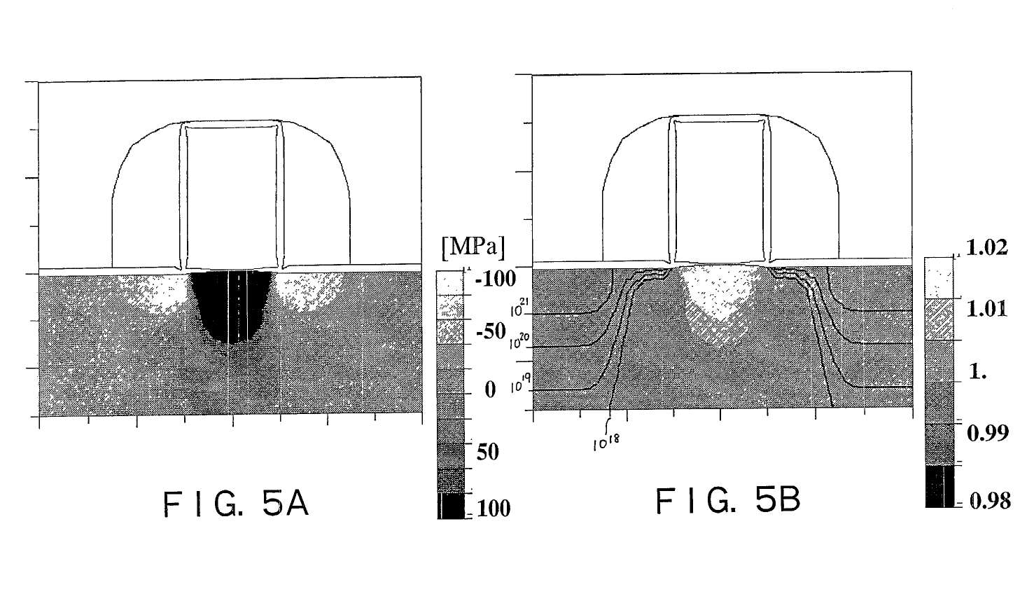

FIG. 5B is a diagram showing the process result of the step S16 of FIG. 4. FIG. 5B shows an example of selecting the diffusion coefficient as the physical property value, and a boron concentration as the physical amount. FIG. 5A shows the stress distribution in the silicon substrate right under the gate, similarly to FIG. 3A. The stress of FIG. 5A expresses a hydrostatic pressure obtained as an average value between the stress in a crosswise direction and the stress in a lengthwise direction.

As shown in FIG. 5B, in the step S16 of FIG. 4, the changing amount of the diffusion coefficients of the boron (the region right under of the gate of FIG. 5) in the cases of taking the stress distribution into consideration and not taking the stress distribution into consideration is displayed on the concentration distribution of the boron (a contour line in a right-and-left direction of the gate in FIG. 5) in the superimposing manner.

As shown in FIG. 5, although the diffusion coefficient of the boron increases by 1-2% due to the compression stress right under the gate, the boron does not exist right under the gate almost at all. Accordingly, it may be unnecessary to take the stress into consideration.

Thus, because the present embodiment displays the changing amount of the physical property values in the cases of taking the stress into consideration and not taking the stress into consideration on the distribution of the physical quantity in the superimposing manner, it is possible to easily and accurately estimate whether or not the it is necessary to take the stress into consideration when the semiconductor device is developed.

Furthermore, in the step S16 of FIG. 4, the changing amount of the viscous coefficients in the cases of taking the stress into consideration and not taking the stress into consideration may be displayed on the stress distribution in the superimposing manner.

Furthermore, the mobility may be selected as the physical property value, the current path may be selected as the physical amount, and the changing amounts of the mobility in the cases of taking the stress distribution into consideration and not taking the stress distribution into consideration may be displayed on the distribution of the current path in the superimposing manner.

(Third Embodiment)

The third embodiment has a feature that a ratio of the changing amount of the physical property value at one fabrication condition relative to the changing amount of the physical property value at the other fabrication condition is calculated.

Because the third embodiment has also a block configuration similar to that of FIG. 1, the detailed description will be omitted.

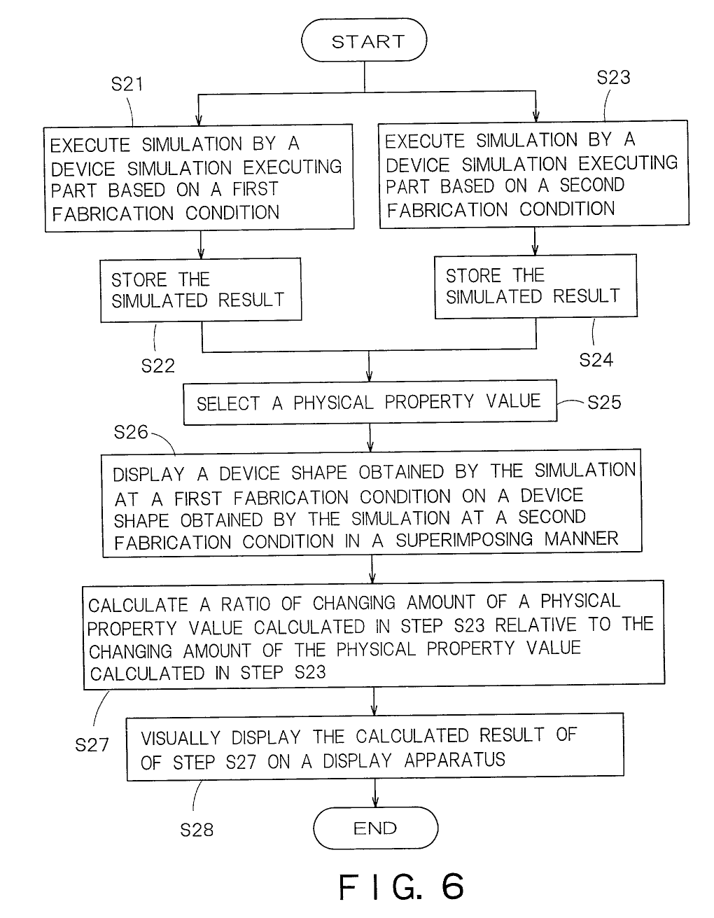

FIG. 6 is a flow chart showing processes of the third embodiment of a simulation apparatus according to the third embodiment. First of all, the device simulation executing part 1 executes a simulation based on a first fabrication condition (step S21), and stores the simulated result (step S22). In step S21, the changing amount between the physical property value in the case of taking the stress distribution into consideration and the physical property value in the case of not taking the stress distribution into consideration is calculated.

Furthermore, the device simulation executing part 1 executes a simulation based on a second fabrication condition (step S23), and stores the simulated result (step S24). The changing amount of the physical property values in the cases of taking the stress distribution into consideration and not taking the stress distribution into consideration, based on the second fabrication condition.

Which of the steps S21 and S22, and the steps S23 and S24 may be executed on ahead.

Subsequently, the physical property value is selected (step S25), and the device shape obtained by the simulation at the first fabrication condition is displayed on the device shape obtained by the simulation at the second fabrication condition in the superimposing manner (step S26).

Subsequently, a ratio of the changing amount of the physical property value calculated by the step S23 relative to the changing amount of the physical property value calculated by the step S21 is calculated (step S27). More specifically, (μ2(σ2)/μ2)/(μ1(σ2)/μ1) is calculated with regard to the carrier mobility, (D2(σ2)/D2)/(D1(σ1)/D1) is calculated with regard to the diffusion coefficient, and (η2(σ2)/η2)/(η1(σ1)/η1) is calculated with regard to the viscous coefficient.

Subsequently, the calculated result of the step S27 is visually displayed on the display apparatus 4 (step S27).

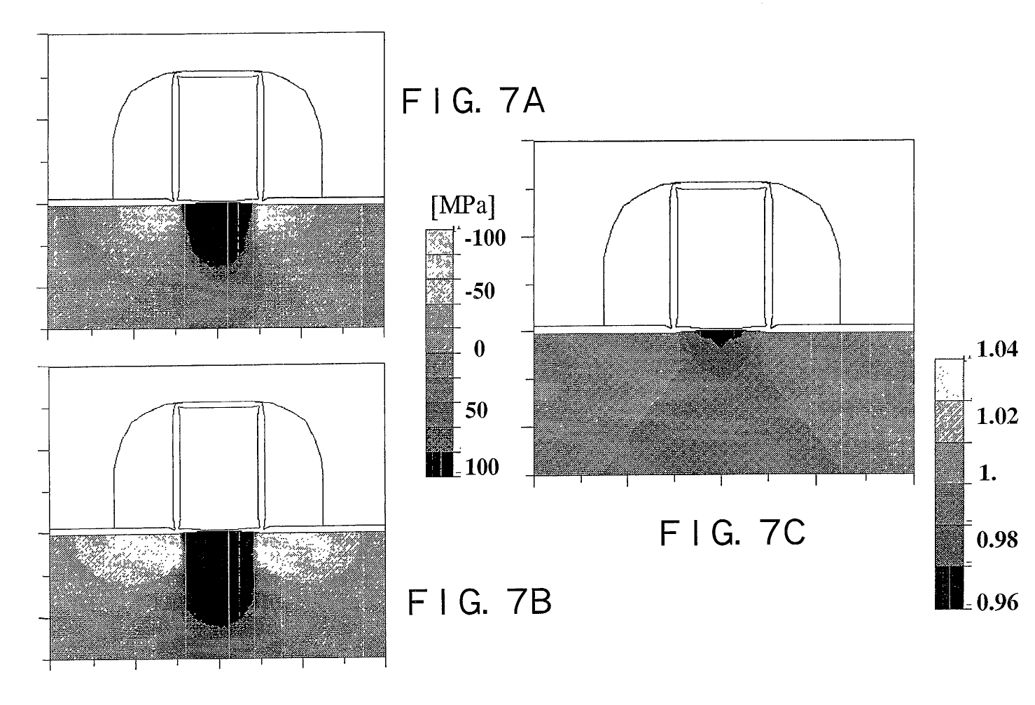

FIG. 7 is a diagram showing the process result of the step S27. FIG. 7A shows a stress distribution occurring in the silicon substrate of the bulk, and FIG. 7B is the stress distribution occurring in a SOI substrate. The stresses of FIG. 7A and FIG. 7B express a hydrostatic pressure obtained as an average value between the stress in the crosswise direction and the stress in the lengthwise direction.

FIG. 7C shows the changing amount of the mobility of the electrons calculated from the stress distribution of FIG. 7A and FIG. 7B. More specifically, FIG. 7C shows a ratio of the changing amount of the mobility of the electrons in the SOI substrate relative to the changing amount of the mobility of the electrons in the silicon substrate of the bulk.

Because the stress value occurring in the SOI substrate is higher than the stress value occurring in the silicon substrate, the mobility of the electron becomes low by 2-4% in the SOI substrate relative to the silicon of the bulk.

Thus, in the third embodiment, it is possible to compare the changing amounts of the physical property due to the stress with each other, with regard to a plurality of the semiconductor device experimentally fabricated on the SOI substrate, for example, it is possible to calculate the changing amount due to the stress of the semiconductor device experimentally fabricated on the SOI substrate. Therefore, it is possible to exactly grasp how the stress is affected when the fabrication processes are changed. Accordingly, it is possible to select the proper fabrication process, thereby reducing the fabrication cost and shortening the development period.

In each of the above-mentioned embodiments, specified forms for visualization are not limited to the illustrated one.

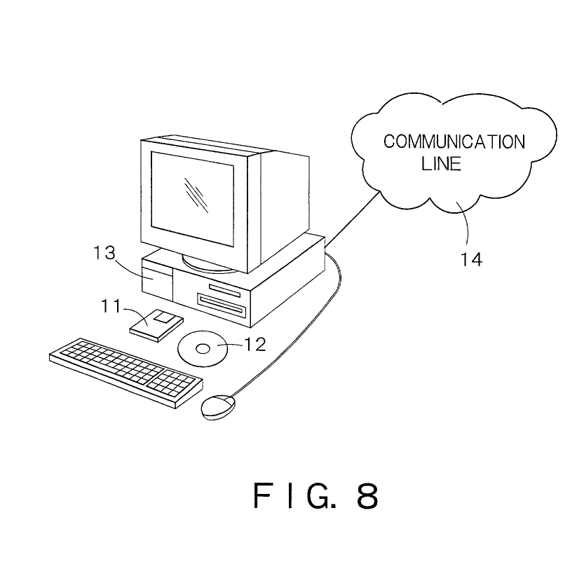

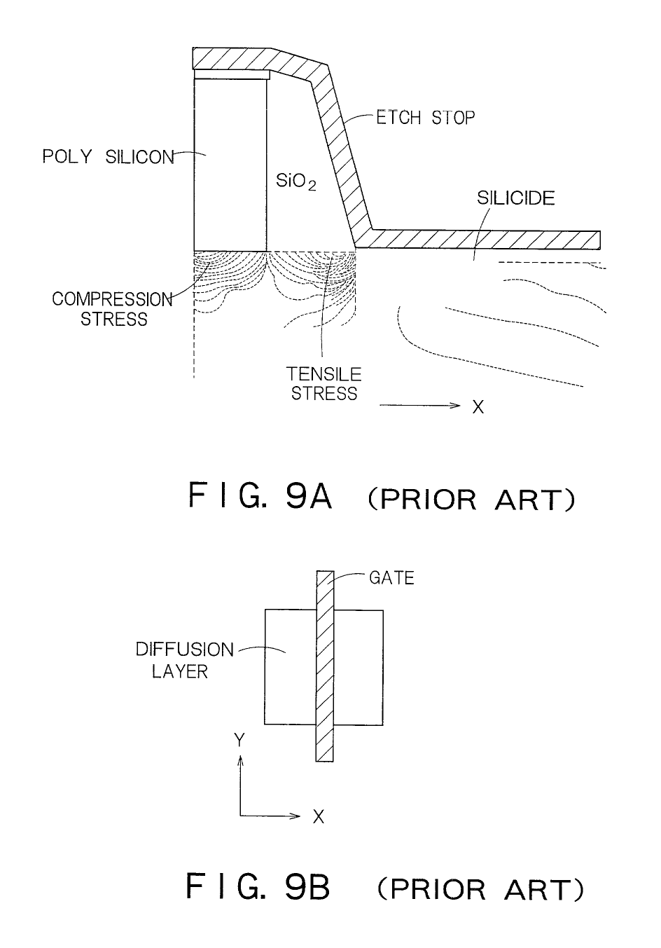

Furthermore, the simulation apparatus described in each of the above-mentioned embodiments may be composed of a hardware or a software. When composed of the software, a program for realizing functions of the simulation apparatus is contained in recording mediums such as a floppy disk 11 or a CD-ROM 12 shown in FIG. 8, and may be read by the computer 13 to carry out it. The recording medium is not limited to portable mediums such as a magnetic disk or an optical disk. Fixed type recording mediums such as a hard drive apparatus or a semiconductor memory are also applicable to the present invention.

Furthermore, the program for realizing functions of the simulation apparatus may be delivered via a communication line (including a wireless communication line) such as an Internet. Furthermore, the program may be transmitted via a wired line or a wireless line such as the Internet at the encrypted, modulated, and compressed state, or by being contained in the recording medium.

What is claimed is:

1. A simulation apparatus configured to estimate properties of a semiconductor device, comprising:
a first calculating part configured to calculate a first value corresponding to a prescribed physical property value by taking a prescribed physical quantity into consideration, with regard to at least a partial region of said semiconductor device;
a second calculating part configured to calculate a second value corresponding to said physical property value without taking said physical quantity into consideration, with regard to at least a partial region of said semiconductor device, and
a visualizing part configured to display, in a prescribed form, a correlation between said first and second values.

2. The simulation apparatus according to claim 1,
wherein said prescribed physical quantity is a stress distribution inside said semiconductor device occurring during a process of fabricating said semiconductor device.

3. The simulation apparatus according to claim 2,
wherein said stress is a hydrostatic pressure obtained as an average value between the stress in a crosswise direction and the stress in a lengthwise direction.

4. The simulation apparatus according to claim 1,
wherein said physical property value is a value relating to at least one of a mobility of carriers, a carrier trap, a fixed electrical charge, a tunnel probability, a lifetime of carriers, generation-extinction speed of pair of carriers, a diffusion coefficient and a viscous coefficient.

5. The simulation apparatus according to claim 1,
wherein said visualizing part illustrates changing amount of said first value relative to said second value, with regard to at least a partial region of said semiconductor device.

6. A simulation apparatus configured to estimate properties of a semiconductor device, comprising:
a first calculating part configured to calculate a first value corresponding to a prescribed physical property value by taking a first physical quantity into consideration, with regard to at least a partial region of said semiconductor device;
a second calculating part configured to calculate a second value corresponding to said physical property value without taking said first physical quantity into consideration, and
a visualizing part configured to display a correlation between said first and second values on a distribution of said second physical quantity is a superimposing manner.

7. The simulation apparatus according to claim 6,
wherein said prescribed physical property value is a diffusion coefficient, said first physical quantity is a stress, and said second physical quantity is a concentration of atoms or molecules.

8. The simulation apparatus according to claim 7,
wherein said stress is a hydrostatic pressure obtained as an average value between the stress in crosswise direction and the stress in lengthwise direction.

9. The simulation apparatus according to claim 6,
wherein said prescribed physical property value is a viscous coefficient, and said first and second physical quantities are stress values.

10. The simulation apparatus according to claim 9,
wherein said stress is a hydrostatic pressure obtained as an average value between the stress in crosswise direction and the stress in lengthwise direction.

11. The simulation apparatus according to claim 6,
wherein said prescribed physical property value is a mobility, said first physical quantity is a stress, and said second physical quantity is a current path.

12. The simulation apparatus according to claim 11,
wherein said stress is a hydrostatic pressure obtained as an average value between the stress in crosswise direction and the stress in lengthwise direction.

13. A simulation apparatus configured to estimate properties of a semiconductor device, comprising:
a first correlation calculating part configured to calculate a correlation between a first value corresponding to a prescribed physical property value obtained by taking a prescribed physical quantity into consideration and a second value corresponding to the physical property value obtained without taking the physical quantity into consideration, based on the result of simulation carried out on a first simulating condition;
a second correlation calculating part configured to calculate a correlation between a third value corresponding to a prescribed physical property value obtained by taking a prescribed physical quantity into consideration and a fourth value corresponding to the physical property value obtained without taking the physical quantity into consideration, based on the result of simulation carried out on a second simulating condition; and
a visualizing part configured to display a relevance between the correlation calculated by said first correlation calculating part and the correlation calculated by said second correlation calculation part, with regard to at least a partial region of said semiconductor device.

14. The simulation apparatus according to claim 13,
wherein said visualizing part displays a ratio of changing amount of said third value relative to said fourth value relative to the changing amount of said first value relative to said second value.

15. The simulation apparatus according to claim 13,
wherein said prescribed physical quantity is a stress distribution inside said semiconductor device occurring during the fabrication of said semiconductor device.

16. The simulation apparatus according to claim 15,
wherein said stress is a hydrostatic pressure as an average value between the stress in crosswise direction and the stress in lengthwise direction.

17. The simulation apparatus according to claim 15,
wherein said physical property value is a value relating to at least one of a mobility of carriers, a carrier trap, a fixed electrical charge, a tunnel probability, a lifetime of carriers, generation-extinction speed of pair of carriers, a diffusion coefficient and a viscous coefficient.

18. A simulation method of estimating properties of a semiconductor device, comprising:
calculating a first value corresponding to a prescribed physical property value by taking a prescribed physical quantity into consideration, with regard to at least a partial region of said semiconductor device;
calculating a second value corresponding to said physical property value without taking said physical quantity into consideration, with regard to at least a partial region of said semiconductor device, and
displaying, in a prescribed form, a correlation between said first and second values.

19. A simulation method of estimating properties of a semiconductor device, comprising:
calculating a first value corresponding to a prescribed physical property value by taking a first physical quantity into consideration, with regard to at least a partial region of said semiconductor device;
calculating a second value corresponding to said physical property value without taking said first physical quantity into consideration, and
displaying a correlation between said first and second values on a distribution of said second physical quantity is a superimposing manner.

20. A simulation method of estimating properties of a semiconductor device, comprising:
calculating a correlation between a first value corresponding to a prescribed physical property value obtained by taking a prescribed physical quantity into consideration and a second value corresponding to the physical property value obtained without taking the physical quantity into consideration, based on the result of simulation carried out on a first simulating condition;
calculating a correlation between a third value corresponding to a prescribed physical property value obtained by taking a prescribed physical quantity into consideration and a fourth value corresponding to the physical property value obtained without taking the physical quantity into consideration, based on the result of simulation carried out on a second simulating condition; and
displaying a relevance between the correlation between said first and second values and the correlation between said third and fourth values, with regard to at least a partial region of said semiconductor device.
